(19) United States
(12) Patent Application Publication
(10) Pub. No.: US 2009/0121497 A1
(43) Pub. Date: May 14, 2009

(54) Door security system

(76) Inventor: Donald W. Mahala, Baltimore, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 12/290,207

(22) Filed: Oct. 28, 2008

Related U.S. Application Data
(60) Provisional application No. 61/002,036, filed on Nov. 6, 2007.

(51) Int. Cl. E05C 19/00

(52) U.S. Cl. 292/259 R

(57) ABSTRACT

A security bar system for physically preventing unwanted opening of a door. The system preferably comprises an elongated, rigid, generally cylindrical rod that is adapted to extend in front of the door between a pair of mounting brackets. The door bar is adapted to axially penetrate, and be restrained by and between, the bracket members. The door bar is an elongated, rigid, generally cylindrical rod adapted to extend across and block the door. The bar is adapted to be received at opposite sides of the door within suitable brackets through which the bar may be axially extended, and from which the bar may be axially withdrawn when desired.

Two mounting brackets include an elongated, threaded shaft adapted to be inserted into a doorjamb. Each bracket has a central orifice of sufficient diameter to admit one end of the bar. The bar is of sufficient length to extend between the doorjambs, and partially beyond each bracket.

### CROSS REFERENCE TO RELATED APPLICATION

This application is based upon and claims benefit of copending and co-owned U.S. Provisional Patent Application Ser. No. 61/002,036 entitled “Door Security System”, filed with the U.S. Patent and Trademark Office on Nov. 6, 2007 by the inventor herein, the specification of which is incorporated herein by reference.

### BACKGROUND OF THE INVENTION

1. Field Of The Invention

The present invention relates generally to hardware and apparatus for securing conventional doors or the like. More particularly, the present invention is related to a door bar system adapted to be removably, yet securely, mounted between opposite sides of the width of a door to prevent the door from being opened.

2. Background Of The Prior Art

With the increasing nationwide crime rate, the need for security devices is readily apparent. In the prior art, a variety of systems have been employed to mount door bars or braces for security reasons. Most of these suffer from the disadvantage that at least one end of the door bar contemplated must be permanently coupled to one side of the door to be blocked. Since the apparatus cannot be easily removed, it may sometimes present an aesthetic objection. Moreover, such systems tend to constantly “get in the way” and they may interfere with desired ingress and egress. Because of the structure of known prior art devices, many cannot be mounted in “right sided” or left sided” operation. For example, doors may be hinged on the left or on the right, and the associated conventional doorknob, door latch, or the like, will be located upon the opposite side. Since applications vary in this manner, a viable door bar system must be able to quickly and easily adapt for mounting on either left sided or right sided applications.

Examples of prior art door latch or door bar security systems in which a portion of the door bar is securely and permanently mounted adjacent the door may be seen in the following U.S. Pat. Nos.: 4,017,104; 3,986,741; 4,067,598; and 3,955,844. U.S. Pat. Nos. 4,119,336 and 3,971,582 include door latching assemblies in which some form of slotted locking member is provided. U.S. Pat. No. 4,082,332 provides a door bar system in which the bar may be axially removed from one bracket, while vertical displacement to an opposite side of the bar will quickly result in discharge of the bar from its intended operation.

There remains a need, however, for a simple door security device that can be easily installed and rapidly engaged or disengaged, and that prevents unwanted opening of the door.

### SUMMARY OF THE INVENTION

The present invention comprises a security door system for preventing undesired, forcible opening of a door. The system is adapted to firmly restrain the door from unwanted displacement.

To this effect, the system contemplates an elongated, rigid, generally cylindrical bar adapted to extend across and block a door to prevent the door from being opened. The bar is adapted to be received at opposite sides of the door within suitable brackets, mounted on the doorjamb, through which the bar may be axially extended, and from which the bar may be axially withdrawn when desired.

Two mounting brackets include an elongated, threaded shaft adapted to be inserted into a doorjamb. Each bracket has a central orifice of sufficient diameter to admit one end of the bar. The bar is of sufficient length to extend between the doorjambs, and at least, partly beyond each bracket.

It is, therefore, an object of the present invention to provide a door security system that avoids the disadvantages of the prior art.

An object of the present invention is to provide a door security system for maximizing the security of a dwelling, room, or other enclosure.

Yet another object of the present invention is to provide a door security system of the character described that would allow easy consumer installation without extensive modification to the existing structure. A related object is to provide a door security enhancement system that may be installed at minimum cost.

A still further object of the present invention is to provide a door security system of the character described that may be used in conjunction with either right sided or left sided applications. In other words, because of the symmetry of the parts involved, the door bar system described may be employed equally advantageously in conjunction with doors that open from the left or from the right.

Yet another object is to provide a door bar assembly that may be quickly and easily removed from use when desired without unfastening complex hinge assemblies or the like.

It is a further object of the present invention to avoid the use of bar hinge or bar pin assemblies that are rigidly, permanently coupled to opposite sides of the door in prior art designs.

Yet another object of the present invention is to provide a door security system of the character described that would only minimally disturb the aesthetics of the dwelling (or other enclosure) to be protected.

A still further object of the present invention is to provide a door security system of the character described that cannot be dislodged from its mounting clamps without being axially maneuvered by the occupant of the protected dwelling.

This invention enables a simple, yet effective, door security system. The system includes a bar that is sized and configured to extend between two brackets mounted on either side of the door in order to prevent opening of the door. In a preferred embodiment, the bar comprises a solid steel rod and the brackets comprise forged-steel threaded eyebolts.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows a security device according to the present invention.

FIG. 2 shows a marking for positioning a portion of the security device according to the present invention.

FIG. 3 shows a portion of the security device according to the present invention.

FIG. 4 illustrates a portion of the installation instructions according to the present invention.

FIG. 5 shows a storage feature of the security device according to the present invention.

FIG. 6 shows a security device according to another embodiment of the present invention.

### DETAILED DESCRIPTION OF THE INVENTION

The invention summarized above and defined by the enumerated claims may be better understood by referring to the following description, which should be read in conjunction with the accompanying drawings in which like reference symbols are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

The invention provides safety and protection from home invasions. It is more important than ever that extra steps be taken to protect individual and family safety. The security device of the present invention installs in less than fifteen minutes on the frame of any inward facing door and makes entry through that door nearly impossible by turning an ordinary wood door into the strength rivaling that of a steel security door. Unlike wood doors with a standard latch that can be easily broken through, a door with the security device of the present invention is nearly impossible to penetrate.

In one embodiment of the present invention, a security device comprises two (2) heavy-duty ⅝-inch×4-inch forged-steel threaded eyebolts and one (1) ½-inch diameter×3-foot solid steel rod. The threaded eyebolts are screwed deep into each doorjamb of the frame surrounding the door. Once the eyebolts are in place, the rod can be inserted into the eyebolts.

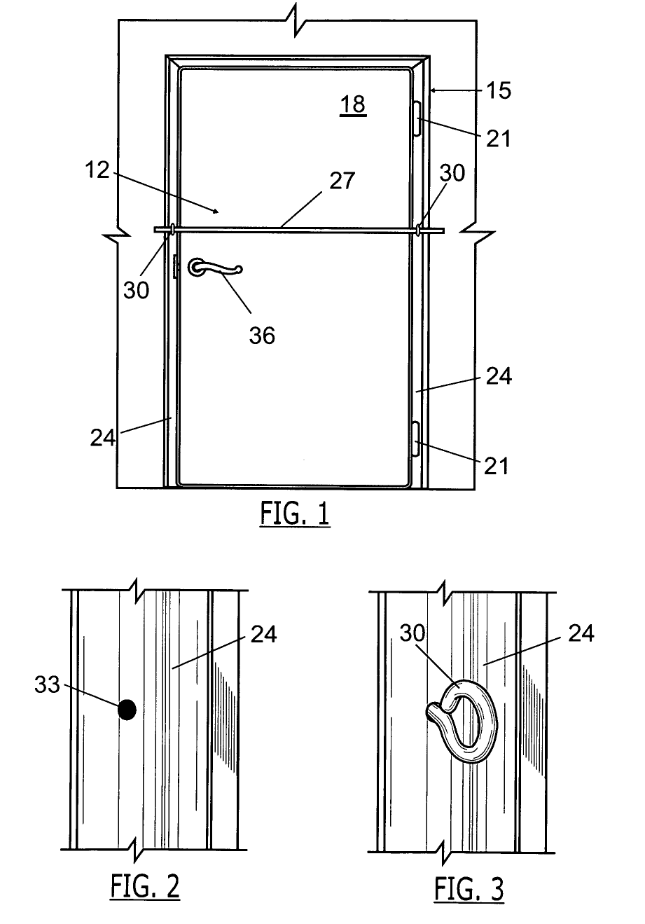

Referring to the drawings, FIG. 1 shows a standard door in a closed position with a security bar installed according to the present invention. The door opening includes a doorframe with a door hung on hinges within the door opening and a vertically oriented doorjamb. The door is selectively moveable from a closed position to an open position. In a preferred embodiment, the bar comprises a ½-inch diameter×3-foot solid steel rod. Two solid-steel eyebolts are installed into the doorjamb on each side of the doorframe, on the inwardly opening side of the door. When the door is closed, the solid-steel rod is inserted to pass through both eyebolts. The length of the steel rod is selected based on the width of the door and the distance between both sides of the doorframe. The rod should be of sufficient length to extend sufficiently beyond each eyebolt.

As shown in FIGS. 2 and 3, a felt-tip or other marker can be used to pre-mark the desired location for two eyebolts. The first step is to determine the best location for the eyebolts. In a preferred embodiment, the eyebolts should be installed approximately half the distance down the length of the door, but far enough above the door handle so as to not interfere with operation of the door handle. In general, use a felt-tip or other marker to pre-mark the location for the eyebolts on the doorjamb. Each eyebolt should be installed on opposite sides of the doorframe and at equal heights to ensure the rod does not slide out of the eyebolts prematurely. It is important that the eyebolts be installed at the same height.

The strength of the security device not only depends on the solid-steel rods and solid-steel eyebolts but also depends on the strength of the surface they are being attached to. Ensure the doorframe is sturdy enough to support the security device. Preferably, holes for the eyebolts should be pre-drilled using a small drill bit (up to ⅛-inch). Drill the holes several inches into the doorjamb. Predrilling the holes will help to prevent the doorjamb from splitting or cracking and makes installation easier.

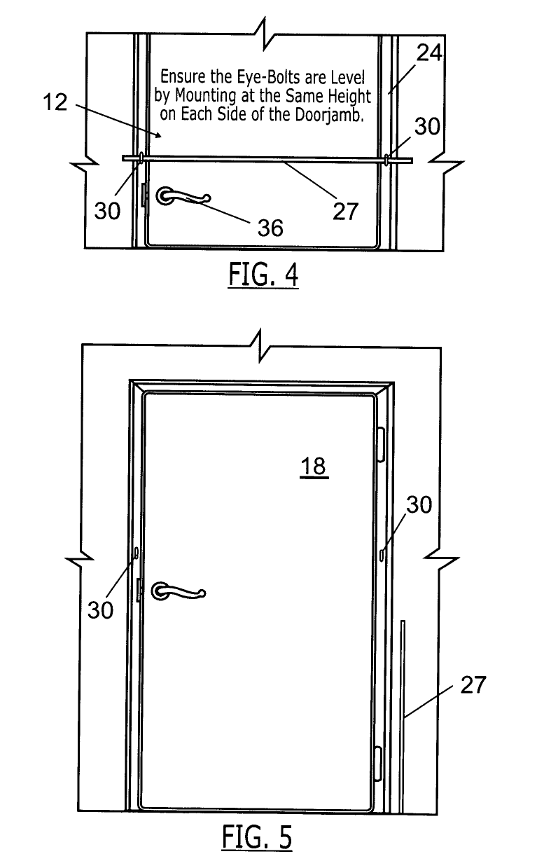

Install one eyebolt on the left side of the doorframe, and the other eyebolt on the right side of the doorframe. Screw the eyebolts fully into the doorjamb. It is possible to use the rod to help turn the eyebolt by inserting an end of the rod through the eyebolt and turning while placing pressure on the eyebolt. Installation should ensure the eyebolts remain straight and level while screwing the eyebolts into the doorjamb. It is important that when the rod is installed, the rod remains level. The width of the eyebolts must not be more than approximately 2-inches less than the length of the steel rod. In a preferred embodiment, the eyebolts comprise heavy-duty ⅝-inch×4-inch forged-steel threaded eyebolts. The eyebolts are screwed deep into the doorjamb, as shown in FIG. 4. There must be enough room at least on one side of the rod to allow the rod to be removed by sliding the rod out and above the eyebolts. (Note, the indication of width in FIG. 4 is merely an example for a particular door. Other dimensions can be used to fit different size doors.)

As shown in FIG. 5, when not in use, the rod can be stored behind the door and out of sight. With the rod and one eyebolt hidden behind the open door, most people will not even notice the second eyebolt in the doorjamb making this system more pleasant to look at in the home than other types of door security systems.

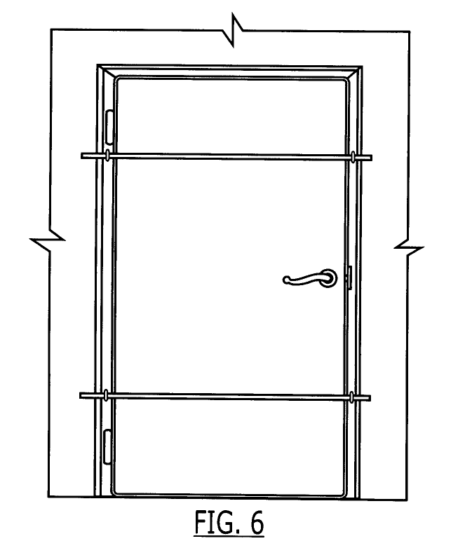

FIG. 6 shows a security device according to another embodiment of the present invention. More than one security device can be installed on a single door. For example, if installing two security devices on the same door for additional security, the first set of eyebolts should be placed approximately one-quarter of the distance down from the top of the door. The second set of eyebolts should be placed approximately one-quarter of the distance up from the bottom of the door. In all cases, installation should make sure the eyebolts are installed on the doorframe in a position where they will not cause the doorjamb to splinter or crack, and each pair of eyebolts should be installed at the same height so that the rod remains level when installed.

To use, locate the best door(s) in the home to install the security device. Consider at a minimum installing the door security device on all inward facing bedroom doors to ensure safety while sleeping. A separate security device can be installed on other doors, such as entryway doors, for added security. Make sure the rod(s) for the security device(s) can be removed quickly in the event of an emergency. It is not recommended to place the security device on doors from which the rod(s) cannot be removed quickly by any individual in that room.

One of the key advantages of the present invention over the prior art is a safety improvement that allows the device to be removed quickly. In less than 5 seconds, the bar can be removed and the door opened (even in limited visibility). This is a very important differentiator over other prior art devices since it allows the device to be removed quickly in the event of a fire or other emergency. Existing prior art devices are more complex and time consuming to remove in particular should visibility be impaired during a fire or other emergency.

Another advantage is that the simple design reduces the complexity and time to engage the device over other prior art devices. With no moving parts and a less complicated design, the device can be easily engaged (in less than 5 seconds) by anyone, including children and the elderly. Furthermore, unlike other prior art devices, this invention uses no moving parts. With no moving parts, there is no maintenance or wear-and-tear. The design eliminates the need for maintenance or part replacement for the life of the product, improving the durability and longevity over other prior art devices.

The simple design of this device makes installation much easier, allowing the device to be installed by most individuals in less than fifteen minutes and typically requires no tools. The simple design and ease of installation makes the device more desirable by consumers. The majority of existing devices required a much more complicated labor-intensive installation, require tools not supplied by the manufacture for the installation, and have a more permanent footprint. Additionally, removal of existing devices would require substantial repair to the door infrastructure. Removal of the device according to the present invention would only require two holes to be filled with putty and re-painted. Removal of this device is significantly less destructive to the infrastructure.

Finally, another advantage is that the appearance of this device is improved over existing devices. With only one eyebolt visible when the door is open, it is less likely to be noticed. Most of the existing devices are much larger, commercial like in design, and more noticeable. The simple, less obtrusive design of this invention would be more desirable and marketable to consumers in home installations.

The invention has been described with references to a preferred embodiment. While specific values, relationships, materials, and steps have been set forth to describe concepts of the invention, it will be appreciated by persons skilled in the art that numerous variations and/or modifications may be made to the invention as shown without departing from the spirit or scope of the basic concepts and operating principles of the invention. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments shown and described will obviously occur to those skilled in the art upon becoming familiar with said underlying concept. It is intended to include all such modifications, alternatives and other embodiments in this invention. It should be understood, therefore, that the invention may be practiced otherwise than as specifically set forth herein. Consequently, the present embodiments are to be considered in all respects as illustrative and not restrictive.

What is claimed is:

1. A door security system, comprising:
a door opening to a room including a doorframe with a vertically oriented doorjamb, and a door hung on hinges within the door opening for opening and closing said door opening;
a first eyebolt installed in the doorjamb at a first selected height, said first eyebolt being installed on the doorjamb on a side on which the door opens inward;
a second eyebolt installed in the doorjamb at the first selected height, said second eyebolt being installed on the opposite doorjamb across the door opening from said first eyebolt on the side on which the door opens inward; and
a first bar, sized and configured to extend between said first and second eyebolts.

2. The door security system of claim 1 wherein the eyebolts comprise heavy-duty ⅝-inch×4-inch forged-steel threaded eyebolts.

3. The door security system of claim 1 wherein the bar comprises a ½-inch diameter solid steel rod.

4. The door security system of claim 1 wherein said bar has a length at least as long as the distance between said first and second eyebolts.

5. The door security system of claim 4 wherein said bar has a length that is greater than the distance between said first and second eyebolts.

6. The door security system of claim 1 wherein said eyebolts are installed approximately half the distance down the length of the door.

7. The door security system of claim 6 wherein said second eyebolt is installed at the same height as the first eyebolt such that the bar being placed between said eyebolts is level.

8. The door security system of claim 1, further comprising:
a third eyebolt installed in the doorjamb at a second selected height, said third eyebolt being installed on the doorjamb on a side on which the door opens inward;
a fourth eyebolt installed in the doorjamb at the second selected height, said fourth eyebolt being installed on the opposite doorjamb across the door opening from said third eyebolt on the side on which the door opens inward; and
a second bar, sized and configured to extend between said third and fourth eyebolts.

9. The door security system of claim 1 wherein said first and second eyebolts are installed approximately one quarter the distance down the length of the door and said third and fourth eyebolts are installed approximately three quarters the distance down the length of the door.

10. A method for securing a doorway to a room, the doorway comprising a door opening to the room including a doorframe with a vertically oriented doorjamb, and a door hung on hinges within the door opening for opening and closing said door opening, the method comprising the steps of:
installing a first eyebolt in the doorjamb at a first selected height, said first eyebolt being installed on the doorjamb on a side on which the door opens inward;
installing a second eyebolt in the doorjamb at the first selected height, said second eyebolt being installed on the opposite doorjamb across the door opening from said first eyebolt on the side on which the door opens inward; and
placing a first bar to extend between said first and second eyebolts, wherein said first bar is sized and configured to fit within openings in said eyebolts and to extend at least partly beyond each eyebolt.

11. The method of claim 10 wherein the eyebolts comprise heavy-duty ⅝-inch×4-inch forged-steel threaded eyebolts.

12. The method of claim 10 wherein the bar comprises a ½-inch diameter solid steel rod.

13. The method of claim 10 wherein said eyebolts are installed approximately half the distance down the length of the door.

14. The method of claim 13 wherein said second eyebolt is installed at the same height as the first eyebolt such that the bar being placed between said eyebolts is level.

15. The method of claim 10, further comprising the steps of:
installing a third eyebolt in the doorjamb at a second selected height, said third eyebolt being installed on the doorjamb on a side on which the door opens inward;
installing a fourth eyebolt in the doorjamb at the second selected height, said fourth eyebolt being installed on the opposite doorjamb across the door opening from said third eyebolt on the side on which the door opens inward; and
placing a second bar to extend between said third and fourth eyebolts, wherein said second bar is sized and configured to fit within openings in said eyebolts and to extend at least partly beyond each eyebolt.

16. The method of claim 10 wherein said first and second eyebolts are installed approximately one quarter the distance down the length of the door and said third and fourth eyebolts are installed approximately three quarters the distance down the length of the door.
